(19) United States
(12) Patent Application Publication
(10) Pub. No.: US 2014/0114602 A1
(43) Pub. Date: Apr. 24, 2014

(54) METHODS, DEVICES AND SYSTEMS TO PROCESS X-RAY DIFFRACTION DATA

(71) Applicant: The Trustees of Columbia University in the City of New York, New York, NY (US)

(72) Inventors: Simon Billinge, Brooklyn, NY (US); Christopher Farrow, Austin, TX (US); Timur Dykhne, New York, NY (US); Pavol Juhas, New York, NY (US)

(73) Assignee: The Trustees of Columbia University in the City of New York, New York, NY (US)

(21) Appl. No.: 14/138,511

(22) Filed: Dec. 23, 2013

Related U.S. Application Data
(63) Continuation of application No. PCT/US2012/043843, filed on Jun. 22, 2012.
(60) Provisional application No. 61/500,787, filed on Jun. 24, 2011.
(60) Provisional application No. 61/525,602, filed on Aug. 19, 2011.
(60) Provisional application No. 61/563,258, filed on Nov. 23, 2011.

(51) Int. Cl. G01N 23/207

(52) U.S. Cl. CPC G01N 23/207
USPC 702/104

(57) ABSTRACT

The disclosed subject matter relates, inter alia, to improved devices, systems and methods for processing raw data collected from X-ray total scattering analysis of a material, which may be solid, liquid, in suspension, or in solution. This devices, systems and methods described are advantageous because they drastically reduce the amount of user interaction required to compute a PDF from diffraction data, reduce the computing time necessary to compute the PDF, and allows for automated, on-the-fly computation of PDFs without significant degradation of the PDF quality and little input from the user.

### CROSS REFERENCE

This application is a continuation of PCT/US2012/043843, filed Jun. 22, 2012, which claims priority to to U.S. Provisional Application Ser. Nos. 61/500,787, filed Jun. 24, 2011; 61/525,602, filed Aug. 19, 2011; and 61/563,258, filed Nov. 23, 2011, the entire contents of each of which are incorporated herein in their entireties.

### GRANT INFORMATION

This invention was made with government support under Grant DMR-0703940 awarded by the U.S. National Science Foundation. The government has certain rights in the invention.

### FIELD

The subject matter relates, inter alia, to devices, systems and methods for processing X-ray diffraction (XRD) data, including total scattering XRD data; neutron scattering data, including total scattering neutron data; and electron scattering data, including total scattering electron data, in which corrections are on an ad hoc basis.

### BACKGROUND

Determination of the local, short-range (or long-range) structure of a material is important to understand the properties of a material. Materials and their properties are often characterized by varying degrees of disorder. Total scattering or atomic pair distribution function analysis utilizes Bragg scattering and diffuse scattering from a material to look beyond the average structure and examine the local, or short-range structure. Total scattering pair distribution functions (PDF) can reveal the probability of finding an atom a distance “r” away from another given atom, and thereby reveal the atomic arrangements of the material. Determining the atomic arrangements is the key to understanding and possibly predicting the properties of materials. The use of PDF to investigate the local structures of non-crystalline pharmaceutical compounds, such as amorphous and nanostructured materials, has prompted much interest from the pharmaceutical community.

Total scattering X-ray diffraction (XRD) data can be processed into total scattering pair distribution functions (PDFs) by software known as PDFGetX2. PDFGetX2 is a GUI-driven program that obtains the PDFs of the X-ray powder diffraction data. The program offers users flexibility and control in choosing which corrections to apply to X-ray scattering intensities in order to convert them into PDFs. However, due to the myriad of options available to users, as well as the esoteric nature of many of the corrections, PDF generation typically requires an extensive amount of user input. It is also time intensive for a user to understand the fundamentals of the technique, and as such, likely cannot be automated for high throughput of many data sets.

Therefore, there is a need for a high-throughput system, apparatus, method, and computer program provided on a computer-readable medium that utilizes limited user input to only a few parameters, generates PDFs in a fraction of a second, and can be automated to batch-process PDFs.

### SUMMARY

In accordance with the disclosed subject matter, provided is a quantitatively reliable method for calculating the PDF of a material that requires little user input and little user expertise. The disclosed subject matter is expected to allow widespread adoption of the PDF as a tool for characterizing materials. The methods disclosed herein are especially useful to the pharmaceutical industry, as they t may easily be used by non-experts to characterize nanocrystalline and amorphous materials; an assessment that has heretofore been very difficult. Accordingly, the disclosed methods and instrumentation is an important development, especially as nanoscale drugs become more prevalent in the pharmaceutical industry. As high-powered x-ray and neutron sources become increasingly more available, and as they are coupled with sophisticated instruments and software, the PDF is expected to have increasing importance to the field of pharmaceutical characterization for the pharmaceutical industry. Other industries that also include use of nanostructured materials will also find the new methods and devices useful.

The PDF is the probability of finding an atom a distance r away from any given atom, and can be obtained from x-ray, neutron, or electron scattering data. PDFs provide useful information about the local structure of crystalline and non-crystalline materials, including amorphous and nanostructured materials. As a result, PDFs provide industries an improved means of characterizing materials, and in particular provide the pharmaceutical industry with superior techniques useful to characterize the local structures of pharmaceutical compounds, such as non-crystalline and nanocrystalline pharmaceutical compounds—compounds that are often mischaracterized by prior art methods.

Generally, the PDF of a material may be calculated by measuring the raw electron, x-ray, or neutron scattering function of a material, correcting and normalizing the raw scattering function to account for experimental errors, yielding the reduced structure function (“RSF”) and Fourier transforming the RSF into the PDF. The electron, x-ray, or neutron scattering data may be collected, for example, from isotropic samples such as powders, disordered nanoparticles, amorphous materials, liquids, solutions, and suspensions.

Present computer programs that can perform this process offer users too much flexibility and control in choosing exactly which corrections to apply to X-ray scattering intensities in order to convert them PDFs. Due to the myriad of options available to users as well as the esoteric nature of many of the corrections, PDF generation requires significant input from expert users. Thus, the current programs are not universal in nature because few users have the necessary expertise to use them. Furthermore, the current programs are time intensive and cannot be automated for high throughput of many data sets. The disclosed subject matter provides methods, devices, and systems, to allow users to obtain quantitatively reliable PDFs from diffraction data with ease, as compared to prior methods which were time consuming and difficult to use. In one embodiment, the methods, devices, and systems, allow the user to calculate RSFs or PDFs “on the fly” in fractions of a second, and “on-demand” (upon user request).

In accordance with one aspect, a method is provided to calculate the RSF of a material. The method includes obtaining a measured scattering function of the material, determining a first mathematical correction function for the measured scattering function, determining a second mathematical correction function for the measured scattering function, and applying the first and optionally second correction functions to the measured scattering function to obtain the RSF. The first mathematical correction function can be, for example, an additive or subtractive function. The second mathematical correction function can be, for example, a multiplicative or divisive correction function.

The method can calculate the RSF in fractions of a second with little in put from the user. Thus, the RSF can be obtained “on-the-fly” with little user input.

In one embodiment, the RSF is converted to a PDF of the material. The RSF can be converted to the PDF by Fourier transformation or an inverse Fourier transformation.

In accordance with one aspect, a method is provided to calculate the RSF from the experimental data using purely ad hoc corrections. Mathematical (e.g., additive, subtractive, multiplicative and divisive) corrections are determined and applied to the experimental data to generate the RSF, then the RSF may be converted to the PDF or to any related function, as known to one of skill in the art. As long as there are no aberrations to the data with frequencies higher than the closest separation of atoms in the material, and multiplicative corrections such as absorption are not too large, the RSFs and PDFs generated based on these ad hoc correction functions are quantitatively reliable. And even in the case that the multiplicative corrections are strong, these corrections affect only the peak widths in the PDT and therefore only introduce errors into estimations of thermal motions.

According to one embodiment of the disclosed subject matter, the disclosed ad hoc corrections may be applied either directly to the experimental data or to the PDF derived from the experimental data. Alternatively, the ad hoc corrections may be applied in part before conversion of the experimental data to the PDF and in part after conversion of the experimental data to a PDF. Thus, a method is provided to calculate an uncorrected PDF directly from uncorrected or partially corrected experimental data. The uncorrected PDF may then be corrected using purely ad hoc corrections to generate a quantitatively reliable PDF. Alternatively, a limited subset of ad hoc corrections may be applied to the experimental data, the experimental data may be converted to a partially corrected PDF, and then the partially corrected PDF may be further corrected using purely ad hoc corrections.

In another aspect, a device is provided to process raw data collected from x-ray total scattering analysis of a material. The device, for example, can be a computing device programmed to calculate PDFs from the total x-ray scattering of the material. In one embodiment, comprises a computer-readable medium storing a computer program in physical memory of a computing device. The computer program comprises instructions causing the computing device to process raw data collected from x-ray total scattering analysis of a material according to the methods described herein. In an alternative embodiment, the computer program comprises instructions causing the computing device to process raw data collected from neutron total scattering analysis or electron total scattering analysis of a solid according to the methods described herein. The device can process the raw data on-demand upon a user's request.

In another aspect, a system is provided that measures PDFs according to the methods disclosed herein. The system may contain a radiation source, a sample container, and a radiation detector, as well as a computing device to convert a detected diffraction pattern into an RSF or a PDF using the methods described herein. In some embodiments, the system may further comprise a display device to display the RSFs or PDFs to the user.

In another aspect, a method of characterizing materials is provided. Using the methods described herein, it is possible easily and quickly to characterize and distinguish between crystalline materials, nanostructured materials, and amorphous materials. In another embodiment, the disclosed subject matter is a method of characterizing a material within a suspension. In another embodiment, the disclosed subject matter is a method of characterizing a material that is a liquid. In another embodiment, the disclosed subject matter is a method of characterizing a material within a pharmaceutical formulation. A user may also with ease compare one sample to another sample to determine if they have the same structure, or determine the composition of a sample that contains multiple structures.

One exemplary embodiment of the present disclosure can provide methods for processing raw data collected from X-ray total scattering analysis of a solid material using a computing device that is programmed to perform said processing. These exemplary methods can include procedures of, e.g.: mathematically transforming the raw data to provide a structure function; fitting a slow varying function to the structure function; and determining the difference between the structure function and the slow varying function.

A further embodiment of the present disclosure can provide a product, including apparatus and system, which can be configured or can configure one or more processors to perform procedures according to any of the exemplary procedures disclosed herein.

A method for determining an RSF of a material is provided. The method comprises obtaining a measured scattering function of the material; determining a first mathematical correction function for the measured scattering function; determining a second mathematical correction function for the measured scattering function; and applying the first and second correction functions to the measured scattering function to obtain the RSF, wherein the RSF is obtained on-the-fly on-demand by the user. The first mathematical correction can be an additive correction function. The second mathematical correction can be a multiplicative correction function. The application of the additive and multiplicative correction function may comprise subtracting or adding the additive correction function from the measured scattering function to obtain a first corrected scattering function; and dividing or multiplying the first corrected scattering function by the multiplicative correction function to obtain the RSF.

The method can further include the step of converting the RSF to a PDF of the material. The RSF can be converted to the PDF by applying a Fourier transform. The additive correction function can be determined by fitting the RSF with a polynomial. The polynomial has order no greater than 8. The multiplicative correction function can be a constant. The multiplicative correction function can be determined by an iterative procedure. The iterative procedure comprises selecting a multiplicative correction function, calculating an interim RSF or PDF based on the selected multiplicative correction function, evaluating a test of goodness of the interim RSF or PDF, adjusting the multiplicative correction function based on the interim RSF or PDF and the criterion of success, repeating steps until the criterion for success of the interim RSF or PDF satisfies a stopping criterion, wherein steps are not necessarily consecutive steps

The test for goodness comprises evaluating a sharpness of one or more of the peaks in the PDF. The evalution of the sharpness of one or more of the peaks in the PDF comprises calculating the average of the full widths at half maximum of one or more of the peaks in the PDF, or one or more of the peaks in the PDF comprises measuring the height of one or more of the peaks in the PDF. The test for goodness can comprise evaluating a symmetry of the peaks in the PDF. The method symmetry is non-Gaussian or asymmetric.

In another method for determining a PDF of a material, the method includes obtaining a measured scattering function of the material; converting the measured scattering function of the material to an uncorrected PDF of the material; determining an additive correction function for the uncorrected PDF; determining a multiplicative correction function for the uncorrected PDF; and applying the additive and multiplicative correction function to the uncorrected PDF to obtain the PDF of the material, wherein the PDF of the material is quantitatively reliable.

The step of applying the additive and multiplicative correction function comprises subtracting or adding the additive correction function from the uncorrected PDF to obtain a first corrected PDF; and dividing or multiplying the first corrected PDF by the multiplicative correction function to obtain the PDF. The method can further include converting the PDF to an RSF of the material. The PDF can be converted to the RSF by applying an inverse Fourier transform.

A method of characterizing or identifying a material, the method including: measuring a diffraction pattern of the material; calculating from the diffraction pattern using ad hoc corrections a function of the material, wherein the function is either a PDF or an RSF of the material, the function is quantitatively reliable; and determining from the PDF or RSF of the material a characteristic of the material. The method can further comprise determining the structure of the material. The structure of the material may include an amorphous, a crystalline or nanocrystalline phase. The material can have a well-defined structure over length scales of between 10 and 1000 angstroms, between 10 and 500 angstroms, between 10 and 200 angstroms, between 10 and 100 angstroms, or between 10 and 50 angstroms. The method can further comprise the step of determining the number and positions of a plurality of peaks in the PDF, and/or the step determining the local packing of the molecules in the material.

The material can be a solution, suspension or liquid. The concentration of the material within the suspension can be at least 0.05. 0.1, or 0.25 weight percent. The method can determine whether the material is a mixture of multiple structures, and the amount in which each structure of the material is present. For example, the material is a pharmaceutical composition, a drug, or a drug product.

The method can determine from the PDF a characteristic of the material by comparing the PDF of the material to the PDFs of one or more reference materials. It can be determined whether the material has the same structure as one of the plurality of reference materials. The step of determining a characteristic of the material can include determining a stability of the material. The step of determining the stability of the material comprises determining whether a structure of the material has changed since a previous measurement. The method can determine a prediction for whether the material is expected to maintain its current structure.

The method can include the step of determining a characteristic of the material comprising determining whether the material comprises a particular structure. This characteristic of the material may include determining the homogeneity of the material, determining the effect of a processing step on the structure of the material, such as ball milling, melt extrusion, spray drying, or melt-quenching, for example.

In one aspect, a user friendly computer program is provided to determine a quantitatively reliable RSF of a material. The program includes logic to accept a scattering function of a material, logic to determine one or more additive correction functions for the scattering function, logic to determine one or more multiplicative correction functions for the scattering function, logic to subtract the additive correction function from the scattering function to obtain a first corrected scattering function; and logic to divide the first corrected scattering function by the multiplicative correction function to obtain the RSF. The corrective functions are done on an ad hoc basis.

The computer program may further include logic to convert the RSF of the material into a PDF of the material. In this regard, the logic characterizes the material, such as the structure as being crystalline, amorphous, nanostructured, or a combination thereof. The computer program may be part of a system for creating a PDF of a material. The system includes a computer device capable a computing device capable of analyzing a generated signal corresponding to scattered radiation from a sample, wherein said analysis includes converting the electronic signal to the PDF of the material by an application of one or more ad hoc correction functions. The system can have a radiation source configured to irradiate a sample; a radiation detector configured to detect radiation scattered from the irradiated sample; and a generator to generate a signal corresponding to the intensity of the scattered radiation.

The system is capable of creating the PDF on-the-fly and on-demand upon user request. The system applies ad hoc correction functions automatically and requires less input from the user than traditional systems such as those described in US2007/0243620 to Bates, which notes that all instrumental and known thermal contributions to the measured intensity in the XRPD pattern should be removed from the measured intensity along with the true instrumental background. The system may further comprise a display that can be configured to display the PDF of the samples.

According to another exemplary embodiment of the present disclosure, a computer-readable medium storing a computer program in physical memory of a computing device. The computer program can include instructions causing the computing device (e.g., one or more processors) to be configured to process raw data collected from X-ray, neutron, or electron total scattering analysis of a solid material by: mathematically transforming the raw data to provide a structure function; fitting a slow varying function to the structure function at high reciprocal lattice vector values; and determining the difference between the structure function and the slow varying function. These and other objects, features and advantages of the present disclosure will become apparent upon reading the following detailed description of exemplary embodiments of the present disclosure, when taken in conjunction with the appended drawings.

### BRIEF DESCRIPTION OF THE DRAWINGS

FIGS. 1A and 1B illustrate flow diagrams of exemplary methods and/or procedures according to embodiments of the present disclosure;

FIG. 2 is a block diagram of an exemplary system according to an embodiment of the present disclosure;

FIGS. 3A and 3B illustrate a comparison of pair distribution functions of (A) nickel and (B) barium titanate made with PDFGetX2 and an embodiment of the present disclosure;

FIG. 4 illustrates a comparison of pair distribution functions of γ-Al₂O₃ made with PDFGetX2 and an embodiment of the present disclosure;

FIGS. 5A, 5B, and 5C illustrate a comparison of pair distribution functions of (A) bulk CdSe, (B) 37 \acute{Å}, and (C) 22 \acute{Å} CdSe nanoparticles made with PDFGetX2 and an embodiment of the present disclosure; and

FIGS. 6A, 6B and 6C illustrate a comparison of pair distribution functions of (A) CBZ-I, (B) CBZ-III, and (C) nanostructured CBZ made with PDFGetX2 and an embodiment of the present disclosure.

### DETAILED DESCRIPTION OF EXEMPLARY EMBODIMENTS

Total scattering atomic pair distribution functions (“PDF”) is a useful technique for characterizing materials. PDFs can be obtained for example from x-ray, neutron, or electron diffraction data from isotropically scattering samples. The samples can be powders, liquids, gels, suspensions, or polymer matrices. The samples can be amorphous, nanocrystalline, crystalline or distorted crystalline materials. The present disclosure provides user-friendly devices and methods for producing quantitatively reliable PDFs using purely ad hoc corrections. The methods and devices described and embodied herein can process raw data and calculate PDFs on the fly with little input from the user. Thus, the present subject matter provides an efficient, easy to use, on-demand devices, systems, and methods to calculate PDFs useful to characterize materials.

In accordance with one aspect of the disclosed subject matter a method of processing raw data collected from X-ray total scattering analysis of a material is described. In one embodiment, the method includes mathematically transforming the raw data collected or obtained from x-ray total scattering to provide a structure function, fitting a slow varying function to the structure function, and determining the difference between the structure function and the slow varying function. The method optionally includes displaying the determined difference. Additionally, the method can include the step of performing a Fourier transformation of the processed data, and further optionally displaying the Fourier transformed data.

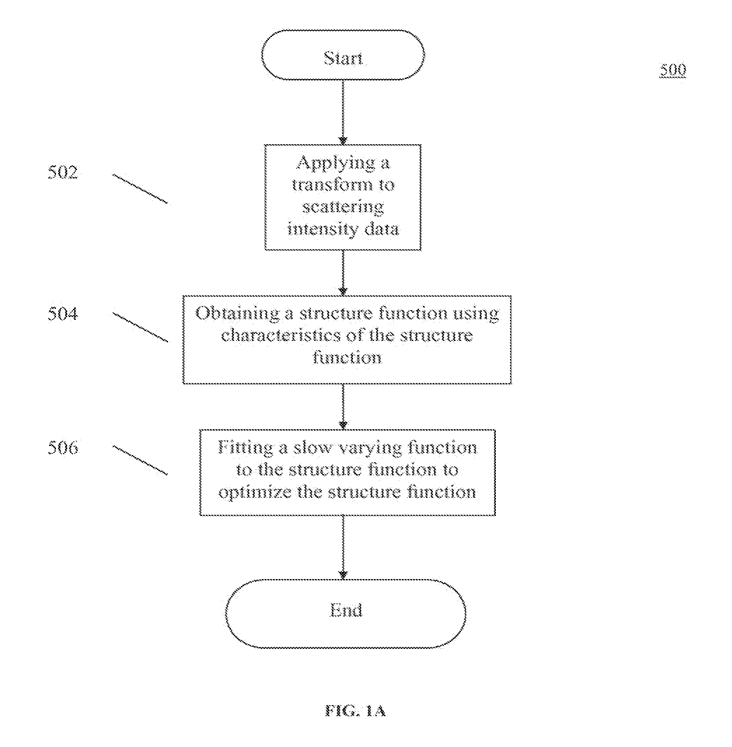

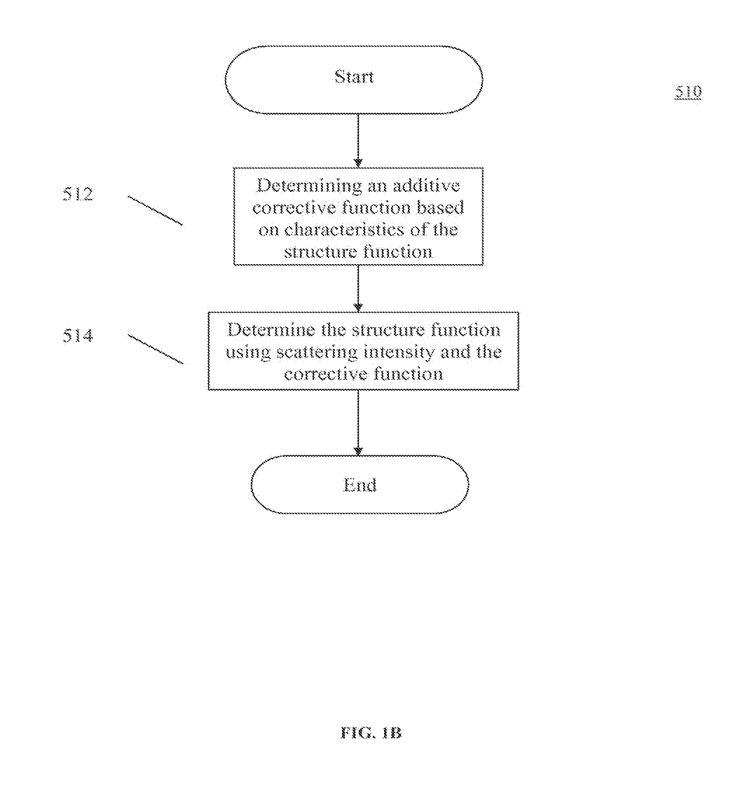

FIGS. 1A and 1B show methods 500 and 510, respectively, according to embodiments of the present disclosure. As shown in method 500, scattering intensity data can be transformed (procedure 502), a structure function can be obtained using characteristics of the structure function (e.g., asymptotic behavior) (procedure 504), and a slow varying function can be fit to the structure function to optimize the structure function (procedure 506). Similarly, in method 510, an additive corrective function can be determined based on characteristics of the structure function (e.g., asymptotic behavior) (procedure 512) and the structure function can be obtained based on the additive corrective function and scattering intensity data (e.g., asymptotic behavior) (procedure 514).

In one embodiment, a reduced structure function (“RSF”) of a material is measured according to techniques familiar to one skilled in the art. The reduced total scattering structure function (“RSF”, “F(Q)”) can be defined in terms of the total scattering structure function, S(Q), as:

F(Q)=Q(S(Q)−1

In this embodiment, the structure function contains the discrete coherent singly scattered information available in the raw diffraction intensity data. It is defined as:

$$S ( Q ) = \frac{{I}_{c} ( Q )}{N {〈 f 〉}^{2}} - \frac{〈 {( f - 〈 f 〉 )}^{2} 〉}{{〈 f 〉}^{2}}$$

which gives

$$\begin{matrix}S ( Q ) - 1 = \frac{{I}_{c} ( Q ) - N 〈 {f}^{2} 〉}{N {〈 f 〉}^{2}} \\ = \frac{{I}_{d} ( Q )}{N {〈 f 〉}^{2}}\end{matrix}$$

Here f is the Q-dependent x-ray or electron form factor or Q-independent neutron scattering length as appropriate and < . . . > represents an average over all atoms in the sample. In this equation, I_{c}(Q) is the coherent single-scattered intensity per atom, which may be determined from the measured scattering function Iₘ(Q) according methods known to those skilled in the art, and I_{d}(Q) is the discrete coherent scattering intensity, which excludes the self-scattering N(ƒ²). The measured scattering function is measured according to methods known to those skilled in the art. The coherent scattering intensity is obtained from the measured scattering function by removing parasitic scattering (e.g., from sample environments), incoherent and multiple scattering contributions, and correcting for experimental effects such as absorption, detector efficiency, detector dead-time time, and so on. The resulting corrected measured intensity is normalized by the incident flux to obtain I_{c}(Q). The self-scattering, N(ƒ²), and normalization, N(ƒ)², terms may be calculated from the known composition of the sample using tabulated values off according to methods familiar to those skilled in the art.

To obtain S(Q)−1 from I_{c}(Q), one can subtract the self-scattering, which has no atom-pair correlation information, and divides by the normalization term. S(Q)−1 oscillates around zero, and asymptotically approaches it at high Q as the coherence of the scattering is lost. If the experimental effects are removed correctly, the resulting F(Q) (the RSF) and G(r) (the PDF) are directly related to, and can be calculated from, structural models. The corrections due to removal of experimental effects are well-controlled in most cases and refinements of structural models result in reduced x² values, which may approach unity in certain cases. Some uncertainty in the corrections can be tolerated because they are mostly long-wavelength in nature (for example, the Compton scattering correction), which results in aberrations in G(r) only at values of r below any physically meaningful region of the PDF.

These corrections may be performed by various programs that are currently available, such as PDFgetX2, RAD, and GudrunX for x-ray scattering data and PDFgetN and Gudrun for neutron scattering data. However, these programs require numerous user data inputs, user interactions, and user judgments, making the programs difficult to use and sometimes requiring a certain level of expertise. The methods and programs of the present disclosure require less to no user input making it more user friendly and universal to users. The presently described subject matter can provide users with on-the-fly processed raw data to define PDFs.

According to one embodiment of the disclosed subject matter, completely ad hoc correction functions may be applied to the measured scattering function to produce quantitatively reliable PDFs. The actual reduced structure function F(Q) of a sample may be calculated directly from the measured scattering function Iₘ(Q). This is contrasted with the conventional method of data reduction, in which one skilled in the art would begin by finding the coherent scattered intensity I_{c}(Q) from Iₘ(Q) by making corrections for factors such as detector dead time, polarization, multiple scattering, background, and so on. The reduced structure function is then determined as described above.

Apart from detector dead time, all of the corrections are either simply additive or simply multiplicative. Assuming that detector dead time is negligible or has been corrected,

I_{c}(Q)=a(Q)Iₘ(Q)+b(Q)

Here a is the Q-dependent multiplicative correction function and b is the Q-dependent additive correction function. These correction functions may vary as a function of Q, or they may be constant functions of Q. According to the prior art, it is these correction functions that are explicitly calculated from theory and applied, based on detailed user inputs about the experimental conditions, in the data reduction programs mentioned above.

Inspection of the above equations shows that an expression for F(Q) itself can be written in the same form without loss of generality:

F(Q)=α(Q)Iₘ(Q)+β(Q)

Writing the equation in this form is useful because information is known about the nature and asymptotic behavior of F(Q) and about the physical corrections that combine to make α and β. According to the present embodiment, this information can be used to determine the properly corrected F (Q) with minimal input information.

Consideration of the nature of the structural and non-structural components of the measured signal suggest that there is a good separation between the frequency of most corrections and the frequency of the structural information in the PDF. The lowest frequency Fourier component in F(Q) coming from a real structural signal is 2π/rₙₙ, where rₙₙ is the length of the shortest inter-atomic bond-length. Therefore additive frequency components in the signal that have lower frequency than this can be coming from nonstructural contributions to the signal. On the other hand, the additive contributions to the signal coming from extrinsic sources can be predominantly much longer wavelength and more slowly varying. Examples are Compton scattering and multiple scattering, both of which vary very slowly with Q.

When mathematical, e.g., multiplicative, corrections have been correctly applied to Iₘ (i.e., α(Q) to unity) a smooth curve can be fit that has frequency components longer than 2π/rₙₙ through the data and subtract it. This can result in a function that can have the correct asymptotic behavior as F(Q), oscillating around zero, and actually can be mF(Q) if there are no experimental aberrations with frequency components higher than 2π/rₙₙ where m can be an unknown constant that can affect the scale of the resulting F(Q) but not its shape. A similar approach has been used for as a post-facto correction to clean-up unwanted oscillations in the low-r region of the PDF.

For example in accordance with the method, the additive correction β(Q) may be applied to Iₘ(Q) by fitting a smooth curve that has only frequency components longer than 2π/rₙₙ to the data and subtracting it. According to one embodiment, the smooth curve that represents the additive correction may be a polynomial, such as for example, a polynomial of order no greater than 8.

This approximation for the additive correction holds in practice very well for all the additive corrections except for those that contain structural information, such as scattering from the sample container. However, if sample container scattering is significant, it can be measured and subtracted straightforwardly according to methods known to those skilled in the art.

According to one embodiment, the multiplicative correction α(Q) may be a constant that scales the peaks of the correlation function uniformly without distorting the structural information.

According to another embodiment, α(Q) may vary as a function of Q. In this embodiment, α(Q) is determined by first examining the effects of an incorrectly-calculated multiplicative correction α′ (Q). In this case, the PDF will calculated as the Fourier transform of the incorrect RSF F′ (Q) instead of F(Q):

F′(Q)=α′(Q)F(Q)

According to this embodiment, a Q-dependent α′ (Q) may be assumed to have a convergent Fourier series expansion over the interval [0, Q′ₘₐₓ], and that Q′ₘₐₓ≧Q. This means that the longest-wavelength component of α′(Q) may be greater than the extent of the measured signal. Defining r′ₙ=2πn//Q′ₘₐₓ, the Fourier expansion of α′(Q) may be expressed as:

$${α}^{′} ( Q ) = \frac{{a}_{0}}{2} + {\sum }_{n = 1}^{∞} ( {a}_{n} cos ( {r}_{n}^{′} Q ) + {b}_{n} sin ( {r}_{n}^{′} Q ) )$$

Here, long-wavelength Fourier components in α(Q) correspond to small values of r′ₙ. Only the cosine components of α′(Q) need be considered, because the sine components do not contribute to the PDF. With this expression for α′(Q), for a given n, F(Q) for a single-peak PDF may be expressed as:

$${F}^{′} ( Q ) ∝ {a}_{n} cos ( {r}_{n}^{′} Q ) \frac{sin ( {Qr}_{ij} )}{{r}_{ij}} = \frac{{a}_{n}}{2} [ \frac{sin ( Q ( {r}_{ij} + {r}_{n}^{′} ) )}{{r}_{ij}} + \frac{sin ( Q ( {r}_{ij} - {r}_{n}^{′} ) )}{{r}_{ij}} ]$$

This equation may be alternatively expressed as:

$${F}^{′} ( Q ) ∝ \frac{{a}_{n}}{2} ( 1 + \frac{{r}_{n}^{′}}{{r}_{ij}} ) \frac{sin ( Q ( {r}_{ij} + {r}_{n}^{′} ) )}{{r}_{ij} + {r}_{n}^{′}} + \frac{{a}_{n}}{2} ( 1 - \frac{{r}_{n}^{′}}{{r}_{ij}} ) \frac{sin ( Q ( {r}_{ij} - {r}_{n}^{′} ) )}{{r}_{ij} - {r}_{n}^{′}}$$

For comparison, the ideal PDF from a single-atom pair (i, j) situated a distance rᵢⱼ; apart can be calculated using Debye's equation for the coherent scattering amplitude:

$${I}_{c} ( Q ) = {\sum }_{i}^{ } {\sum }_{j}^{ } {f}_{i} {f}_{j}^{*} \frac{sin ( {Qr}_{ij} )}{{Qr}_{ij}}$$

From this equation, the Fᵢⱼ(Q) corresponding to the single-peak PDF may be expressed as

$${F}_{ij} ( Q ) ∝ \frac{sin ( {Qr}_{ij} )}{{r}_{ij}}$$

Thus, instead of producing the expected single peak at rᵢⱼ, F′(Q) produces two peaks, one at rᵢⱼ+r′ₙ and one at rᵢⱼ−r′ₙ. Furthermore, the amplitudes of the peaks are different: the peak at rᵢⱼ+r′ₙ is larger than the one at rᵢⱼ−r′ₙ, and the amplitude difference is 2r′ₙ/rᵢⱼ.

Most aberrations coming from imperfect multiplicative corrections should be long-wavelength, for example, extinction and absorption corrections. These only have Fourier components with small r′ₙ in the limit of r′ₙ<<rᵢⱼ. In this case, the two distinct sinc peaks would appear as a single unresolved, but broadened, peak close to the position of the distorted PDF peak at rᵢⱼ. As r′ₙ/rᵢⱼ gets larger, the peak would further broaden, shift slightly, and become asymmetric due to the amplitude difference of the signals. The position of the maximum of an asymmetric peak would be larger than rᵢⱼ due to this asymmetry, and asymmetry would be more pronounced for peaks at lower r. The combined influence from multiple Fourier components would smear out any peak splitting but accentuate the asymmetry of the peak. Thus, the effect of all imperfectly corrected multiplicative aberrations to F(Q) is to broaden peaks in the PDF.

Because all long-wavelength aberrations in the data result in a broadening of the peaks of the PDF, this embodiment uses an ad hoc iterative approach to find the Fourier coefficients of the unknown α′(Q) that generates the sharpest peaks in the PDF. According to this iterative approach, an initial α′(Q) is generated. For example, the initial α′(Q) may be a constant. The initial α′(Q) is then used to generate a PDF, and the PDF is evaluated to determine the symmetry and sharpness of its peaks. α′(Q) is then iteratively adjusted in such a way as to make the resulting PDF peaks as sharp and as symmetric as possible. This adjustment process may be automated. Practitioners skilled in the art will understand that the adjustment of α′(Q) may be carried out by, for example, adjusting the Fourier coefficients of α′(Q) or in any other suitable way.

In a preferred embodiment, the variational approach described above is adjusted to account for peak broadening that has real physical significance, including peak broadening from thermal motion and static disorder.

In another preferred embodiment, the Reduced Structure Function F(Q) is mathematically transformed to a PDF through a sine Fourier transform.

It is understood by those skilled in the art that the equations set forth above may be re-written in a different way depending on the experimental conditions. For example, the PDF may be linked to the scattering through the sine Fourier transform:

$$G ( r ) = \frac{2}{π} {\int }_{{Q}_{min}}^{∝} F ( Q ) sin ( Qr ) d Q$$

wherein Qₘᵢₙ is a Q value that excludes any small angle scattering intensity but includes all the wide-angle scattering (Farrow and Billinge, 2009).

It is understood by those skilled in the art that the RSF or PDF calculated above may be converted by methods known to those skilled in the art to any related function giving information about the structure of a material. For instance, the PDF may be converted to the radial distribution function (“RDF”, R(r)) as follows:

R(r)=rG(r)+4πrp₀

Here, p₀ is the average number density.

Those skilled in the art will understand that peaks in the RDF are symmetric for a Gaussian atomic probability distribution. Thus, it may be useful to evaluate the degree of symmetry of the peaks in the RDF. The symmetry may be evaluated by first determining the position of the peak, r₀, and by determining a number, rₚ to by beyond the extent of the peak. Then one measure of the symmetry is as follows:

$$Δ {R}_{ASYMM} = \frac{{\int }_{{r}_{0}}^{{r}_{p}} R ( {r}_{0} + r ) - R ( {r}_{0} - r ) d r}{{\int }_{{r}_{0}}^{{r}_{p}} d r}$$

Another embodiment of the disclosed subject matter is a computer-readable medium storing a computer program in physical memory of a computing device. The computer program comprises instructions causing the computing device to process the measured scattering function collected from x-ray total scattering analysis by the methods described herein. For example, the computer program can include instructions causing and/or configuring one or more computing devices to process raw data collected from X-ray total scattering analysis of a solid material by, e.g. mathematically transforming the raw data to provide a structure function; fitting a slow varying function to the structure function at high reciprocal lattice vector values; and determining the difference between the structure function and the slow varying function.

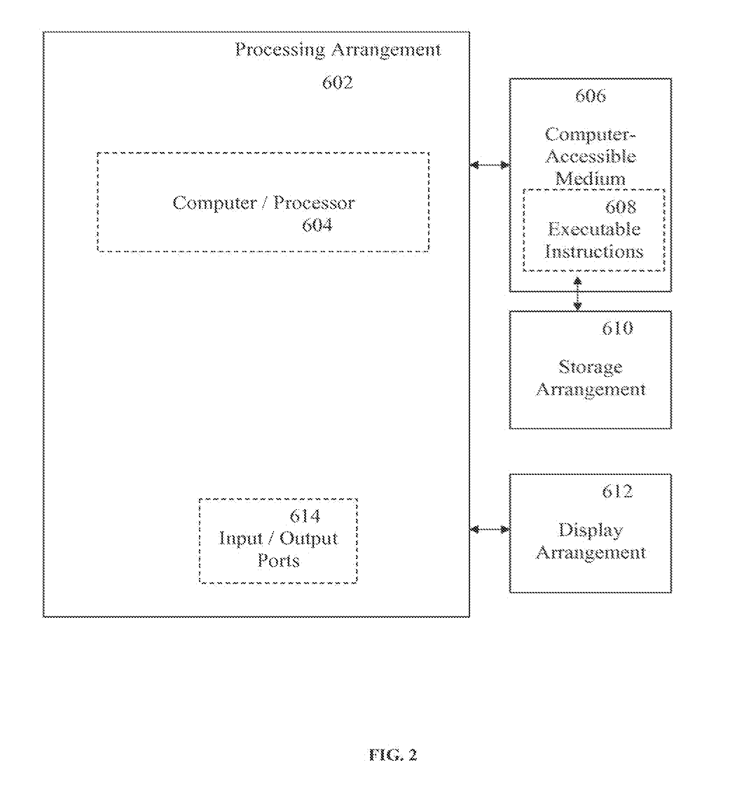

As illustrated in FIG. 2 an exemplary block diagram of an exemplary embodiment of a system according to the present disclosure is provided. The methods in accordance with the present disclosure can be performed by a processor or computing device 602. Processing or computing arrangement 602 can include a computer device or processor 604, such as one or ore microprocessors, ASICs, and use instructions stored on a computer-accessible medium (e.g., RAM, ROM, hard drive, or other storage device).

As shown in FIG. 2, e.g., a computer-accessible medium 606 (e.g., as described herein above, a storage device such as a hard disk, floppy disk, memory stick, CD-ROM, RAM, ROM, etc., or a collection thereof) can be provided (e.g., in communication with the processing arrangement 602). The computer-accessible medium 106 can contain executable instructions 608 thereon. In addition or alternatively, a storage arrangement 610 can be provided separately from the computer-accessible medium 606, which can provide the instructions to the processing arrangement 602 so as to configure the processing arrangement to execute certain exemplary procedures, processes and methods, as described herein above.

Further, the processing arrangement 602 can include an input/output arrangement 614, such as, a wired network, a wireless network, the internet, an intranet, a data collection probe, a sensor, etc. As shown in FIG. 2, the exemplary processing arrangement 602 can be in communication with an exemplary display arrangement 612, which, according to certain exemplary embodiments of the present disclosure, can be a touch-screen configured for inputting information to the processing arrangement in addition to outputting information from the processing arrangement, for example. Further, the exemplary display 612 and/or a storage arrangement 610 can be used to display and/or store data in a user-accessible format and/or user-readable format.

The computer program can comprise instructions causing the computing device to process a measured scattering function collected from neutron scattering analysis or electron scattering analysis by the methods described herein.

In a preferred embodiment, this disclosed subject matter includes a tuning feature that allows the user to dynamically tune a number of different input parameters and quickly see the effect that this will have on the PDF. According to this embodiment, the user-adjustable parameters include a scaling factor for the background; Qₘₐₓ; R_{poly}, which limits the polynomial fit such that no Fourier components of frequency higher than 2π/R are used; and Qₘₐₓᵢₙₛₜ, which limits the range over which the polynomial fit is performed (and which is distinct from Qₘₐₓ, which limits the range over which the Fourier transform is performed). According to a more preferred version, these are the only user-adjustable parameters.

According to this embodiment, the user may either adjust the parameters and press a button to view the PDF on demand, or enable a setting to view the PDF in realtime while tuning the parameters. This tuning feature is possible because the present method is able to process a data set so quickly that it can adjust parameters and calculate a PDF on the fly. In this regard, the user can manipulate the parameters while observing the PDFs being calculated in realtime, thus allowing the user to easily select the best parameters for data processing. In addition, the ability to obtain quantitatively reliable PDFs in real-time with only a small number of tunable parameters makes this embodiment user-friendly and capable of use by non-expert users. The phrase “on the fly” means that only a minimum amount of input is needed by the user. For example in one embodiment, the user inputs the composition of the sample, inputs the file name, and adjusts limited parameters e.g., Qₘₐₓ; R_{poly}, and Qₘₐₓᵢₙₛₜ. This provides user friendly method unlike traditional methods for which the user was required to input ten to twenty parameters, thereby necessitating a user with expert qualifications to perform the method or use the system.

In another embodiment, this disclosed subject matter supports batch processing of PDFs. The user may set up an appropriate configuration file to enable batch processing of data. For instance, if a user has made several hundred temperature-resolved measurements on the same material, then he or she will need to set up just one configuration file and then let the presently disclosed subject matter sequentially process each data set.

In another embodiment, this disclosed subject matter is implemented using the Python programming language using public domain Python libraries including NumPy, SciPy, and MatPlotLib. This means that the program can be used on practically any system that has the freely available (BSD license) Python programming language installed. It has successfully been used on Windows Vista and Windows 7, MacOS, and Linux.

In another embodiment, this disclosed subject matter minimizes user interaction with the program. In order to process a data set, the user needs to provide, in a plain text configuration file, very basic information about the experiment such as the wavelength of the X-rays, neutrons, or electrons used, the chemical composition of the sample, and the range of Q over which to perform the Fourier transform. In normal operation, the user does not need to enable or disable any corrections nor does he or she need to provide values for parameters used in corrections. However, two additional parameters may be adjusted in special cases: R_{poly}, which limits the polynomial fit such that no Fourier components of frequency higher than 2π/R are used; and Qₘₐₓᵢₙₛₜ, which limits the range over which the polynomial fit is performed (and which is distinct from Qₘₐₓ, which limits the range over which the fourier transform is performed).

A further embodiment of the disclosed subject matter is an instrument designed to collect x-ray total scattering data and process the data according to the methods described herein. In an alternative embodiment, the instrument is designed to collect electron or neutron scattering data and process the data according to the methods described herein.

A further embodiment of the disclosed subject matter is a method of characterizing a material. According to this embodiment, the structure of the material may be determined from a PDF or RSF of the material. The structure of the material may be determined by comparing the PDF or RSF of the material to the RSFs or PDFs of known materials. Alternatively, the structure may be determined by matching the PDF or RSF of the material to a theoretical model. Additionally, if the material is determined to comprise multiple structures, the disclosed subject matter includes a method of determining the amount of each structure that is contained within the material.

A further embodiment of the disclosed subject matter is a method of characterizing a drug product. The drug product may be a solid or a liquid, e.g., solution or suspension. The drug product may include in some embodiments nanoparticles of drug or active pharmaceutical ingredient. The nanoparticles can have a particle size distribution in which the D90 (the maximum diameter of the smallest 90% of the nanoparticles by weight) is less than about 400 nm. For example, the nanoparticles may have a D90 of less than 200 nm, 100 nm, 50 nm, 25 nm, 10 nm, or 5 nm.

The disclosed subject matter is not to be limited in scope by the specific embodiments described herein. Indeed, various modifications of the disclosed subject matter in addition to those described herein will become apparent to those skilled in the art from the foregoing description and the accompanying figures. Such modifications are intended to fall within the scope of the appended claims.

As used herein, a “quantitatively reliable PDF” is a PDF that is substantially similar to a PDF that is calculated by applying explicit correction factors, for instance, by using the program PDFGetX2. A “quantitatively reliable RSF” is an RSF that is substantially similar to an RSF that is calculated by applying explicit correction factors, for instance, by using the program PDFGetX2.

As used herein, “X-ray total scattering analysis” means using high energy x-ray diffraction to provide structure-relevant scattering data over a wide range of reciprocal space, including both Bragg scattering and diffuse scattering.

As used herein, “neutron total scattering analysis” means using neutron diffraction to provide structure-relevant scattering data over a wide range of reciprocal space, including both Bragg scattering and diffuse scattering.

As used herein, “electron total scattering analysis⁻ means using electron diffraction to provide structure-relevant scattering data over a wide range of reciprocal space, including both Bragg scattering and diffuse scattering.

Bragg scattering means the set of sharp, discrete diffraction peaks exhibited by an ordered crystalline structure when bombarded with energy sources such as x-rays, neutrons, or electrons. When the structure is not completely ordered, then Bragg scattering intensities are diminished, and diffuse scattering intensities, which are the scattered intensities located outside Bragg scattering intensities, appear.

As used herein, “Bragg angle⁻ means half-scattering angle, and is half of the angle between the incident beam axis and the detector location.

As used herein, the magnitude of the scattering vector, or Q is determined as:

$$Q = \frac{4 πsinθ}{λ}$$

Here, θ is the Bragg angle and λ is the wavelength of the x-ray beam or the neutron beam, as appropriate.

As used herein, “wide range of reciprocal space” means that Q, varies from a Qₘᵢₙ of less than about 2 inverse angstroms to a Qₘₐₓ of at least 5 inverse angstroms. For example, Qₘₐₓ may be above 8.5, 10, 15, 20, or 30 inverse angstroms. For example, Qₘᵢₙ may be as low as about 0 inverse angstrom. Preferably, Q is from about 1 inverse angstrom to about 30 inverse angstroms.

As used herein, “high energy x-ray diffraction” means x-ray diffraction carried out using high frequency x-ray beams, the wavelength of which is less than or equal to about 1.7 angstroms. The isotropic sample for the diffraction may be crystalline, nanocrystalline, amorphous, liquid, or a suspension. For example, high energy x-ray diffraction may be carried out using x-ray beams, the wavelength of which is less than or equal to 0.8 angstroms. Preferably, the x-ray source is synchrotron radiation. It is understood by those skilled in the art that data is obtainable from many x-ray beam sources other than synchrotron radiation, such as laboratory based diffractometers with copper, silver or molybdenum, or other sources. Instruments with a molybdenum source are commercially available from such manufactures as Siemens Corporation (New York, N.Y.) and General Electric (Fairfield, Conn.). A Qₘₐₓ of 18 \acute{Å}⁻¹ is accessible with a silver source lab diffractometer. Such instruments are currently under development by Panalytical B. V. (Almelo, the Netherlands) and Bruker AXS, Inc. (Madison, Wis.).

As used herein, “neutron diffraction” means neutron diffraction using any appropriate method known to one of ordinary skill in the art. For instance, neutron diffraction may be carried out using neutron beams, which may be obtained, for example, by using neutrons from a spallation neutron source.

As used herein, “electron diffraction” means electron diffraction using any appropriate method known to one of ordinary skill in the art. For instance, electron diffraction data may be collected on a standard transmission electron microscope, on a low-voltage electron microscope, or on a scanning electron microscope equipped with a STEM unit.

As used herein, “raw data” means the experimentally collected intensities. Background subtraction may be optionally applied to raw data. Raw data from high energy x-ray, neutron, or electron powder diffraction is usually expressed as Iₑₓₚ(Q).

The term “solid” means a state of matter characterized by resistance to deformation and changes of volume. The solid material may be organic or inorganic. The solid material may also be a crystalline material or a non-crystalline material. Preferably, the non-crystalline material is a nanocrystalline material or an amorphous material. The solid material may also be a distorted material.

The term “liquid⁻ means a state of matter characterized by readiness to flow and resistance to changes of volume. The liquid may be organic or inorganic.

The term “D₉₀” is a measurement of the particle size of a material such as a nanoparticle, and more particularly indicates the particle size distribution of the nanoparticle. A material's D₉₀ is the diameter x such that 90% of the particles in the material have a diameter of x or smaller. Thus, a suspension of nanoparticles having a D₉₀ of less than 200 nm indicates that the size distribution of the nanoparticles is such that 90% of the nanoparticles have a diameter of less than 200 nm. Likewise, a D₅₀ of less than 200 nm suggests that 50% of the nanoparticles have a diameter of less than 200 nm.

The term “suspension” means a particulate solid suspended in a suspension medium. The suspension medium may be any material that is capable of suspending the particulate solid for a period of time sufficient to conduct the analysis described herein.

As used herein, “organic” means any chemical compound, or a salt, a solvate, or a hydrate thereof, which contains one or more carbon atom(s), and “inorganic” means any material that is not organic. “Small molecule organic material” means any chemical compound, or a salt, a solvate, or a hydrate thereof, that contains one or more carbon atom(s) and whose individual molecules are no more than 5 nm in length, for example 3 nm.

As used herein, the term “drug” means (a) articles recognized in the official United States Pharmacopoeia, official Homoeopathic Pharmacopoeia of the United States, or official National Formulary, or any supplement to any of them; (b) articles intended for use in the diagnosis, cure, mitigation, treatment, or prevention of disease in man or other animals; (c) articles (other than food) intended to affect the structure or any function of the body of man or other animals; or (d) articles intended for use as a component of any article specified in clause (a), (c), or (c).

The term “drug product” means any article that contains a drug. Drug products include pure chemical entities or any composition, mixture or formulation containing the drug.

As used herein, “structure” refers to the way in which the individual atoms or molecules of a material are arranged. The structure may be, for example, crystalline, nanocrystalline, or amorphous. As used herein, the structure of a material includes the idea that a single material may contain multiple phases. Each domain with a different structure is considered a different phase. For example, a single material may contain separate domains with different crystal structures; intermixed nanocrystalline domains with different nanocrystalline structures; or intermixed crystalline and amorphous domains.

As used herein, a “domain” is a contiguous region of a material that has one structure throughout.

As used herein, a “crystalline material” means any material that has long-range order. Its structure may be defined by a small number of parameters that define the unit cell (its shape and size) and its contents (atomic coordinates and thermal factors). The complete structure is then obtained by periodically repeating this unit cell over the long range, which means a range of greater than about 100 nm. Crystalline materials include those materials that have a crystal structure but with a different structure on the nanoscale.

A “distorted material” means a material with long-range order, but with significant structural distortions that are not reflected in the average structure.

A “non-crystalline material” is any material that is neither a crystalline material nor a distorted material. A non-crystalline material includes but is not limited to amorphous material and nanocrystalline material.

An “amorphous material” means a material that does not have well-defined structure or has well-defined structure at length scales under about 10 angstroms.

A “nanocrystalline material” means a material that has well-defined structure over length scales of between 10 and 1000 angstroms. The structure of a nanocrystalline material can often be described by a small unit cell and a small number of parameters, but each crystal domain extends only over a length-scale of 10 to 1000 angstroms. Materials whose particle size is significantly larger than 1000 angstroms may be nanocrystalline if they exhibit structural coherence only at the nanometer length scale. Certain nanocrystalline materials appear “amorphous” if analyzed using conventional x-ray diffraction.

As used herein, “mathematically transforming” the raw data to provide a structure function means manipulating the raw data mathematically such that the pre-transformed data, e.g., raw data, is related to the post-transformed data, e.g., the structure function, by a specific function.

As used herein, “fitting” one function to another means varying one or several parameters of a function to minimize the differences between it and another function. Data may be fitted qualitatively or quantitatively according to methods known to those of skill in the art. Models may also be fitted to the PDFs by refining a variety of parameters such as lattice parameters, and thermal factors, using the program PDFgui (Farrow et al., 2007), for example.

As used herein, “slow varying function” means a function that does not vary at frequencies higher than a certain cutoff. One non-limiting example of a slowly varying function may be polynomial function. Preferably, the polynomial function is greater than 5th order. More preferably, the polynomial function is of the highest order that does not introduce frequency components high enough to remove structural information from the final PDF. The preferable order of the polynomial depends on the Q range over which the polynomial fit is conducted. A higher Q range means that a higher order polynomial can be used.

A “goodness of agreement” parameter can be accomplished by evaluating the sum of mean-square difference over a range of the data points defined as Σ(P²ᵢ(1)−P²ᵢ(2)), or by evaluating the sum of the difference squared over a range of the data points defined as, e.g., Σ(Pᵢ(1)−Pi(2))², where Pi(1) can be the value of the ith point in the first set of data, and Pi(2) can be the value of the ith pointing in the second set of data. It may be understood by those skilled in the art that there can be a number of similar expressions that may be used to accomplish the same purpose. For example, each point in the sum can be weighted by a measure of its statistical significance, or the evaluation could be carried out after any low-frequency backgrounds have been removed from the data by fitting and subtraction. Exemplary models can also be fitted to the PDFs by refining a variety of parameters such as lattice parameters, thermal factors, etc. using, e.g., the program PDFgui (Farrow et al., 2007).

The following examples are provided to further illustrate the methods of the disclosed subject matter. These examples are illustrative only and are not intended to limit the scope of the disclosed subject matter in any way.

### EXAMPLES

The examples below demonstrate the quality of the PDFs made in accordance with the present devices, systems, and methods described herein and will be referred to as “PDFGetX3.” Qualitatively, the PDFs are plotted alongside those made with PDFGetX2 and a difference curve. Quantitatively, the same structure model is fit to PDFs made with both PDFGetX2 and PDFGetX3 and the refined parameters are compared to one another. These comparisons were made using measurements of several classes of materials: inorganic materials such as bulk nickel and barium titanate, nanostructured γ-alumina, bulk and nanocrystalline cadmium selenide, and as crystalline and nanostructured phases of the organic pharmaceutical carbamazepine. As illustrated, very different types of materials demonstrate that the present method (“PDFGetX3”) is a robust program that can handle high energy X-ray data.

In all cases, PDFs from both programs are made from the same raw data and use the same input parameters (i.e. Qₘₐₓ, X-ray wavelength, chemical composition, and container background). All data sets except the γ-Al₂O₃ were collected by high-energy synchrotron instruments; however, the synchrotron is not a requirement. PDFGetX3 can handle data from lab-based XRPD instruments as long as the Q-range is sufficiently large. For example, the γ-Al₂O₃ data were collected with a silver anode diffractometer.

Dashed horizontal lines around the difference curve represent ±2 standard deviations. (Proffen et al., 2003; Peterson et al., 2003) Furthermore, following examples in the literature, the range in r space over which the difference curve and the standard deviations were calculated begins with the first nearest neighbor peak, and, in the case of nanoparticles, ends at the maximum size of the nanoparticle.

In general, it was found that the PDFs made by the different programs look somewhat different from one another at r values lower than the first nearest neighbor peak. This is mostly due to differences in how the data are processed by different algorithms and improper applications of corrections. However, peaks in this range (i.e., before the nearest-neighbor peak) have no physical significance. The PDFs look almost exactly the same over the relevant range of data from the nearest neighbor peak and onward.

The PDFs were rescaled by a constant such that the nearest neighbor peak is the same height between PDFs on the same plot. This is a standard procedure and has no effect on data quality. In fact, the scaling parameter is almost always used when comparing experimental data to models. (Peterson et al., 2003) The relative scaling of peaks to one another within the same PDF, which is preserved when scaling by a constant, is, however, important.

Models were fit to the PDFs by refining a variety of parameters such as lattice parameters, thermal factors, and the like using the program PDFgui. (Farrow et al., 2007)

When structure models were fit to PDFs, the largest possible range of r were generally chosen in order to ensure the most independent observations (Egami & Billinge, 2003), unless specific local ordering was the point of interest, as in the case of γ-alumina. However, the low-r region (below the nearest-neighbor peak), which is not physically relevant, was excluded. As a final note, structure models were not fit to the pharmaceutical compounds in the Examples below.

### Example 1

### Nickel and Barium Titanate

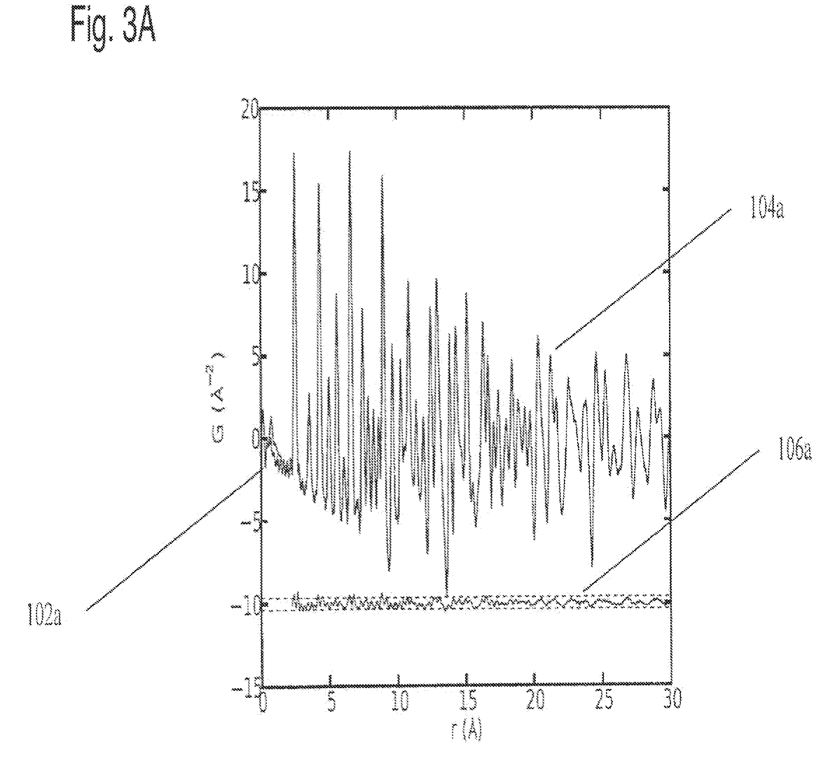

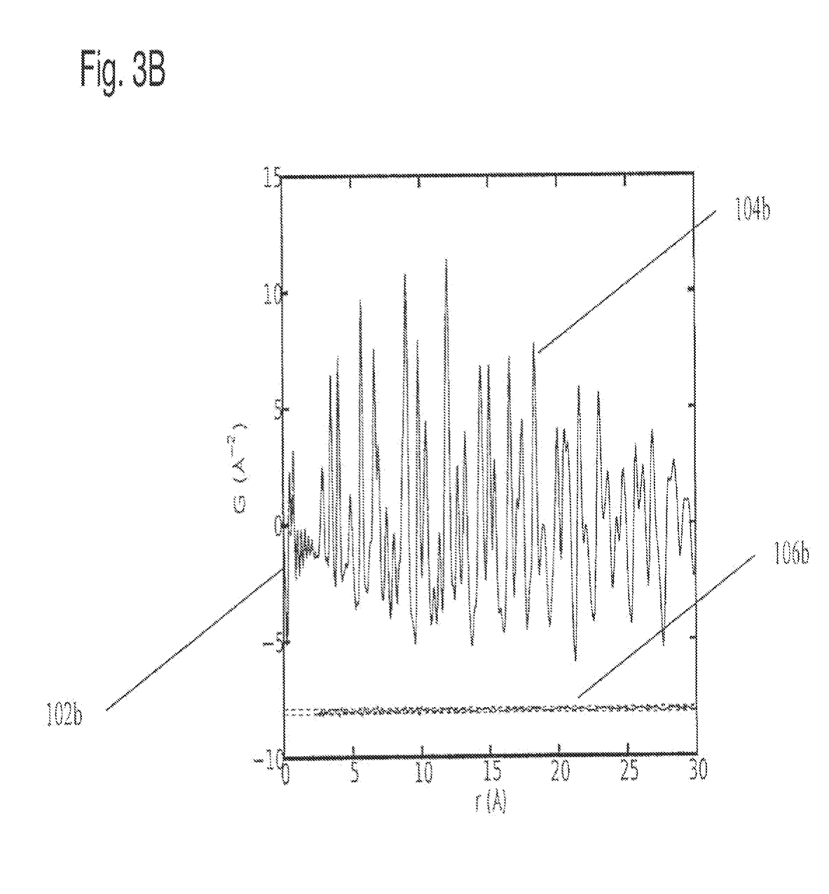

FIGS. 3A and 3B show PDFs of pure nickel (Ni) and barium titanate (BaTiO₃) were measured by the methods described above. As illustrated, both compounds diffracted very well. FIG. 3A shows the PDF of nickel as calculated by PDFGetX2 (102a) and PDFGetX3 (104a), as well as the difference curve (106a). Qmax was 26.0 \acute{Å}⁻¹ in both cases. As can be seen, there is almost no difference between the PDFs after the Ni—Ni nearest neighbor peak (at r=2:2 \acute{Å}). The same behavior is seen in FIG. 3B which depicts results for barium titanate in the same color scheme.

Table 1 below shows the results of fitting the nickel PDFs to a model (Wyckoff, 1967). This model does not require many parameters because only atom type is present, the lattice parameters isotropic (a=b=c), as is the thermal parameter (Uᵢₛₒ=U₁₁=U₂₂=U₃₃). Overall, very good agreement between most of the parameters and the Rw values was seen. The Rw from PDFGetX2 is slightly lower, but the difference is insignificant.

TABLE 1
Model Parameters for Ni.

| Parameter | PDFGetX2 | PDFGetX3 |
|---|---|---|
| Qdamp (\acute{Å}⁻¹) | 0.055 | 0.057 |
| A = b = c (\acute{Å}) | 3.524 | 3.524 |
| δ2 (\acute{Å}2) | 2.525 | 2.705 |
| Uᵢₛₒ (\acute{Å}2) | 0.006 | 0.006 |
| Rw | 0.080 | 0.082 |

Table 2 below shows the refined parameters for fitting BaTiO₃ PDFs to a model (Megaw, 1962). This model required more parameters were than the nickel model, because the lattice parameters are no longer isotropic, and neither are the thermal factors. In addition, a different set of thermal factors was needed for each element. The parameters obtained for PDFGetX2 and PDFGetX3 agree very well with one another. Again, the Rw from PDFGetX2 is slightly lower.

TABLE 2
Model Parameters for BaTiO₃.

| Parameter | PDFGetX2 | PDFGetX3 |
|---|---|---|
| Qdamp (\acute{Å}-¹) | 0.048 | 0.049 |
| a = b (\acute{Å}) | 3.995 | 3.995 |
| c (À) | 4.040 | 4.040 |
| δ₂(\acute{Å}²) | 4.317 | 4.372 |
| U_{11Ba} = U_{22Ba} \acute{Å}²) | 0.005 | 0.005 |
| U_{33Ba} (\acute{Å}²) | 0.005 | 0.004 |
| U_{11Ti} = U_{22Ti} (\acute{Å}²) | 0.009 | 0.008 |
| U_{33Ti}(-\acute{Å}-²) | 0.013 | 0.012 |
| U_{11O} = U_{22O} (\acute{Å}) | 0.011 | 0.010 |
| U_{33O} (\acute{Å}²) | 0.092 | 0.094 |
| Rw | 0.118 | 0.121 |

### Example 2

### Nanocrystalline γ-Alumina

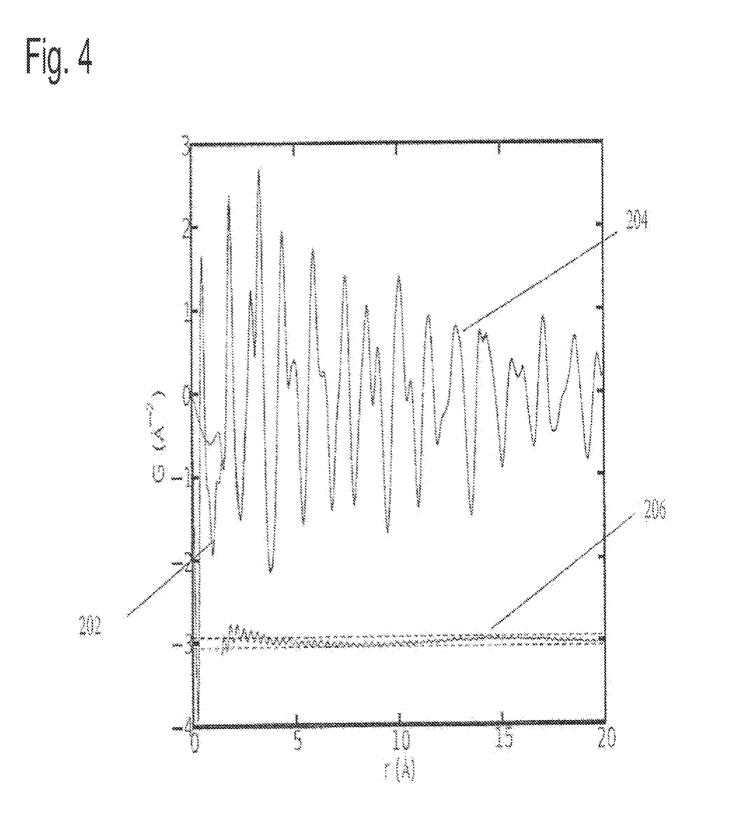

The structure of γ-alumina (Al₂O₃) was investigated using X-rays from a silver anode diffractometer (λ=0.56 \acute{Å}). This phase of Al₂O₃ has a local nanocrystalline structure that is different from the cubic and tetragonal structures of other alumina phases (Paglia et al., 2006). For this reason, a new structure model was developed for the local structure of γ-Al₂O₃ up to r=8 \acute{Å}(ICSD 173014) (Paglia et al., 2006). FIG. 4 shows the PDFs of γ-Al₂O₃ made with PDFGetX2 and PDFGetX3. Very good agreement between the PDFs was observed. In fact, the PDFGetX3 PDF looked better at low r values.

Refined model parameters are shown in Table 3. Unlike in previous cases where a large r range were used for the refinement, in this case the model only applies over the range r=1.5-8 \acute{Å}. Again, the fits to PDFs from the two programs agree very well, and again the Rw from PDFGetX2 is slightly lower.

TABLE 3
Model parameters for γ-Al₂O₃.

| Parameter | PDFGetX2 | PDFGetX3 |
|---|---|---|
| Qdamp (\acute{Å}⁻¹) | 0.077 | 0.081 |
| a (\acute{Å}) | 3.394 | 3.394 |
| b (\acute{Å}) | 2.780 | 2.780 |
| c (\acute{Å}) | 7.042 | 7.039 |
| δ₂ (\acute{Å}²) | 1.131 | 0.991 |
| U_{isoO} (\acute{Å}²) | 0.013 | 0.012 |
| U_{isoA1} (\acute{Å}²) | 0.015 | 0.014 |
| Rw | 0.164 | 0.166 |

As mentioned previously, the γ-Al₂O₃ data were measured using a silver anode lab diffractometer, and not a synchrotron. This example demonstrates that PDFGetX3 is capable of processing data from lab-based instruments (with sufficient Q-range) as well as synchrotrons.

### Example 3

### Cadmium Selenide Nanoparticles

In this example, a more complicated class of materials, nanoparticles, are examined. Generally, nanoparticles do not diffract as well as bulk materials, because they do not have long range order. Smaller nanoparticles diffract worse than larger ones. In fact, it is quite difficult to extract quantitative structural information from nanoparticles using standard crystallography techniques (Billinge & Levin, 2007) (i.e. a copper-anode diffractometer).

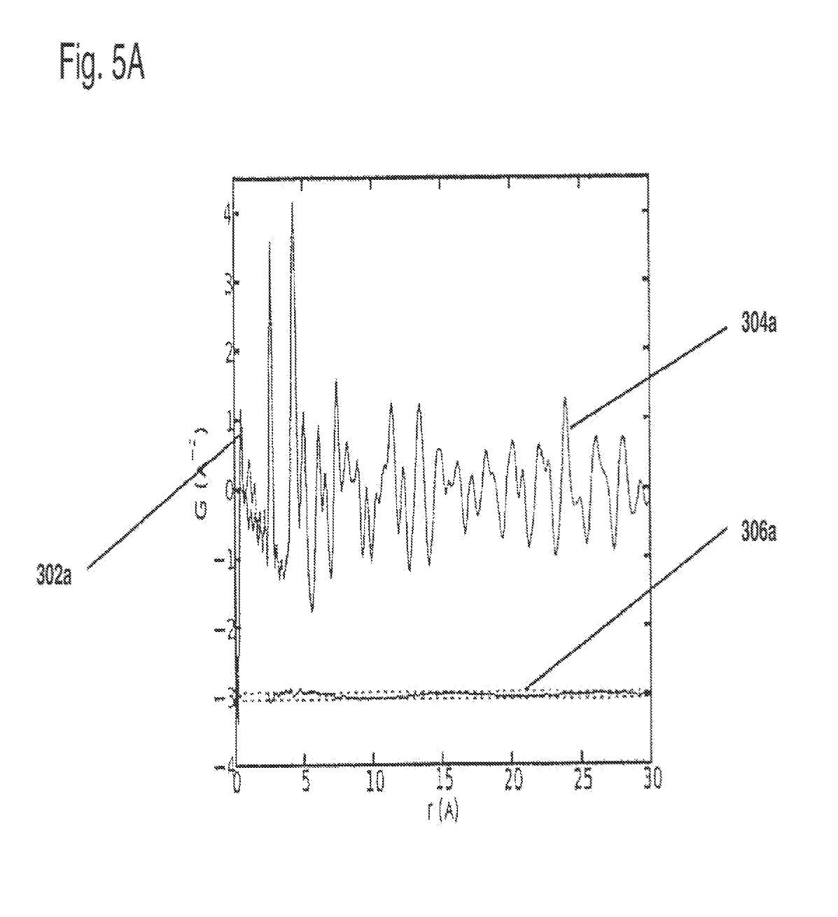

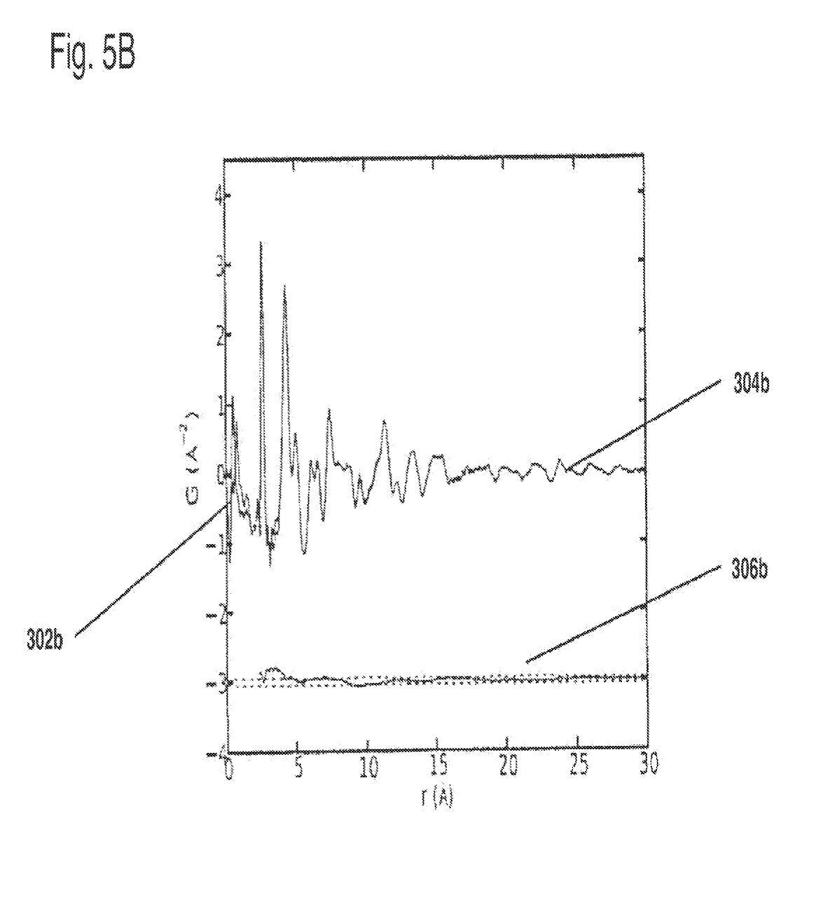

FIG. 5 shows PDFs of three samples of cadmium selenide (CdSe) taken from data that have previously been published by Masadeh et al. from the Billinge Group (Masadeh et al., 2007). The bulk CdSe in FIG. 5A is included for completeness. The nanoparticles in panels FIGS. 5B and 5C were calculated to have diameters of 37 \acute{Å} and 22 \acute{Å}, respectively (Masadeh et al., 2007).

In all three panels of FIG. 5, the PDFs made with the two programs are almost identical. The features are all reproduced beautifully by PDFGetX3, even though many more corrections needed to be applied to the nanoparticle data in PDFGetX2 than were needed for nickel or barium titanate. The low-r region looks a little bit different between the PDFs, especially as the size of the nanoparticles gets smaller, but this region contains no physical information. The PDFs in PDFGetX3 were made in a fraction of a second with little user interaction beyond inputting a few parameters.

Tables 4, 5, and 6 compare the measured PDFs of the CdSe samples to a model (Wyckoff, 1967). The Qdamp that was refined for the bulk was fixed for the nanoparticles. Very good agreement between all parameters was again seen. Furthermore, the Rw was lower for PDGetX3 in two out of three fits.

TABLE 4
Model Parameters for Bulk CdSe.

| Parameter | PDFGetX2 | PDFGetX3 |
|---|---|---|
| Bulk Qdamp (\acute{Å}⁻¹) | 0.059 | 0.059 |
| a = b (\acute{Å}) | 4.299 | 4.299 |
| c(Á) | 7.011 | 7.011 |
| δ₂(À²) | 3.210 | 3.260 |
| U_{11Cd}-U_{22Cd} (\acute{Å}²) | 0.015 | 0.015 |
| U_{33Cd} (\acute{Å}2) | 0.014 | 0.014 |
| U_{11Se} = U_{22Se} (\acute{Å}²) | 0.012 | 0.012 |
| U_{33Se} (\acute{Å}−2) | 0.058 | 0.057 |
| Rw | 0.114 | 0.104 |

TABLE 5
Model Parameters for 37 \acute{Å} CdSe.

| Parameter | PDFGetX2 | PDFGetX3 |
|---|---|---|
| 37 \acute{Å} NP | | |
| a = b (\acute{Å}) | 4.299 | 4.296 |
| c (\acute{Å}) | 7.007 | 7.007 |
| δ2 (\acute{Å}) | 4.661 | 4.736 |
| U_{11Cd} = U_{22Cd} (\acute{Å}²) | 0.022 | 0.022 |
| U_{33Cd} (\acute{Å}²) | 0.003 | 0.004 |
| U_{11Se} = U_{22Se} (\acute{Å}²) | 0.012 | 0.011 |
| U_{33Se}(\acute{Å}²) | 0.199 | 0.197 |
| Particle diameter (\acute{Å}) | 36.38 | 35.33 |
| Rw | 0.194 | 0.173 |

TABLE 6
Model Parameters for 22 \acute{Å} CdSe.

| Parameter | PDFGetX2 | PDFGetX3 |
|---|---|---|
| a = b (\acute{Å}) | 4.294 | 4.295 |
| c (\acute{Å}) | 6.857 | 6.863 |
| δ₂(\acute{Å}²) | 4.966 | 5.198 |
| U_{11Cd}-U_{22Cd} (\acute{Å}²) | 0.043 | 0.042 |
| U_{33Cd} (\acute{Å}²) | 0.040 | 0.041 |
| U_{11Se} = U_{22Se} (\acute{Å}²) | 0.020 | 0.020 |
| U_{33Se} (\acute{Å}²) | 0.233 | 0.221 |
| Particle diameter (\acute{Å}) | 23.13 | 23.34 |
| Rw | 0.262 | 0.265 |

### Example 5

### Drugs

In this example, organic pharmaceutical compounds are examined. These materials can be crystalline, nanostructured, or amorphous. These materials tend to be made up of mostly light, organic elements such as hydrogen, carbon, and oxygen that do not diffract well, therefore even crystal phase pharmaceutical compounds require quite a bit of tinkering in PDFGetX2 to produce a good PDF.

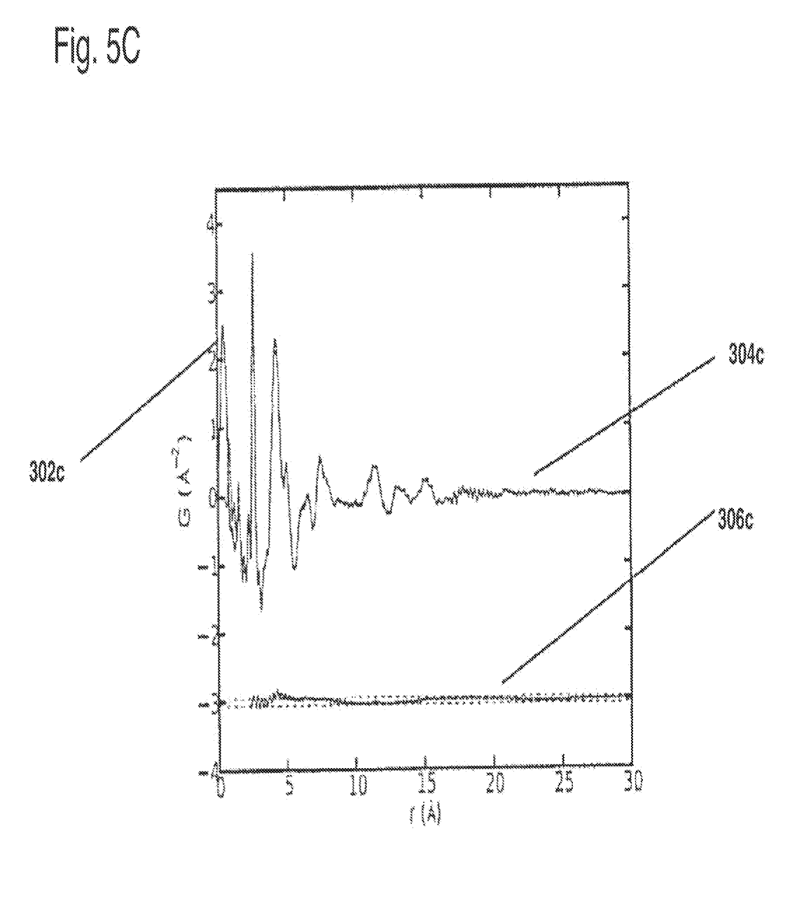

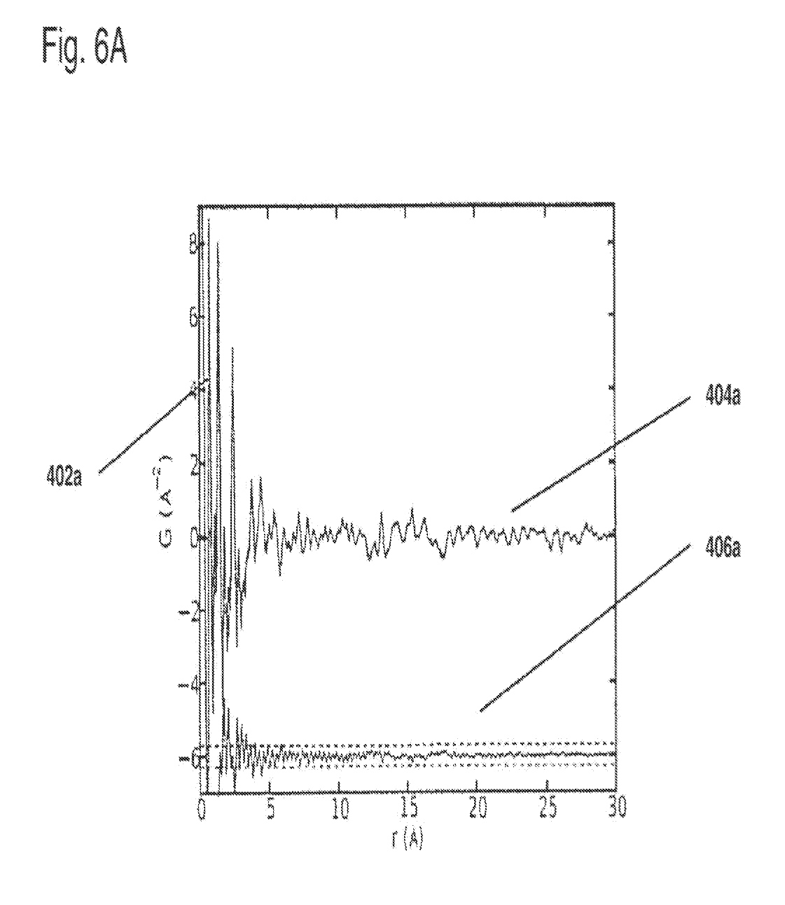

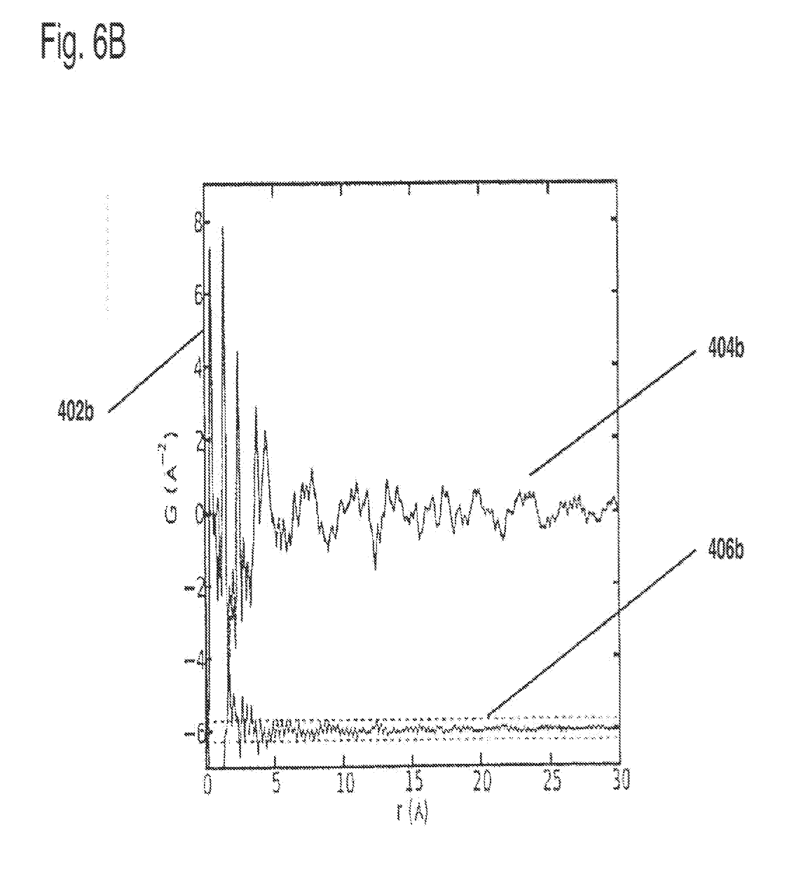

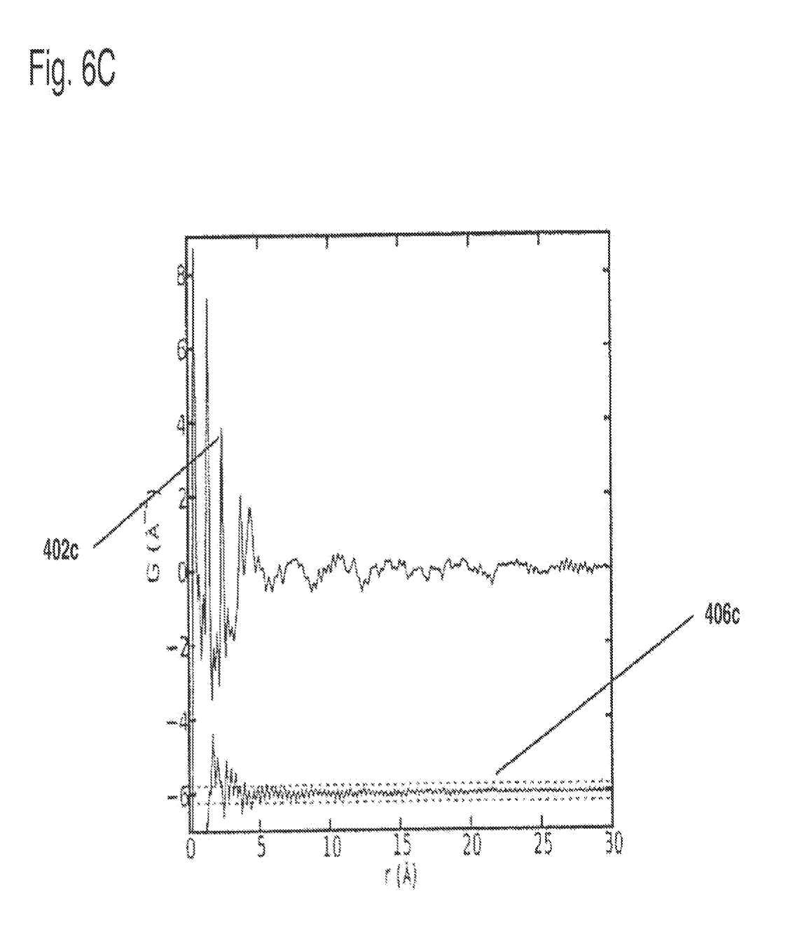

Three phases of the mood stabilizing drug carbamazepine (CBZ) were examined: CBZ-I (FIG. 5A) and CBZ-III (FIG. 5B), both of which are crystalline, and nanostructured CBZ (FIG. 5C). Like the nanoparticles in FIG. 5, the PDFs in FIG. 6 made with PDFGetX2 have quite a bit of noise at low r. In comparison, the PDFs made with PDFGetX3 appear to be quite clean at low r in comparison and require very little manipulation by the user.

What is claimed is:

1. A method for determining an RSF of a material using ad hoc corrections, comprising:
obtaining a measured scattering function of the material;
determining a first mathematical correction function for the measured scattering function; and
applying the first correction function to the measured scattering function to obtain the RSF in an ad hoc basis.

2. The method of claim 1, wherein the method further includes determining a second mathematical correction function for the measured scattering function on an ad hoc basis.

3. The method of claim 1 wherein the first mathematical correction is an additive correction function.

4. The method of claim 2 wherein the second mathematical correction is a multiplicative correction function.

5. The method of claim 2, wherein the first mathematical correction is an additive correction function, and the second mathematical correction is a multiplicative correction function.

6. The method of claim 5 wherein the step of applying the additive and multiplicative correction function comprises:
subtracting or adding the additive correction function from the measured scattering function to obtain a first corrected scattering function; and
dividing or multiplying the first corrected scattering function by the multiplicative correction function to obtain the RSF, wherein all corrections are done on an ad hoc basis.

7. The method of claim 1 further comprising the step of converting the RSF to a PDF of the material.

8. The method of claim 7 wherein the RSF is converted to the PDF by applying a Fourier transform.

9. The method of claim 3 wherein the additive correction function is determined by fitting the RSF with a polynomial.

10. The method of claim 9 where in the polynomial has order no greater than 8.

11. A system for creating a PDF of a material, comprising:
a computing device capable of analyzing a generated signal, wherein said analysis includes converting the electronic signal to the PDF of the material by an application of one or more ad hoc correction functions on-the-fly,
wherein the computing device comprises
logic to accept a scattering function of a material;
logic to determine one or more additive correction functions for the scattering function;
logic to determine one or more multiplicative correction functions for the scattering function;
logic to subtract the additive correction function from the scattering function to obtain a first corrected scattering function; and
logic to divide the first corrected scattering function by the multiplicative correction function to obtain the RSF.

12. The system of claim 11, wherein the logic is capable of converting the RSF of the material into a PDF of the material.

13. The computer program of claim 12, wherein the logic characterizes a structure of the material as crystalline, amorphous, nanostructured, or a combination thereof.

14. The system of claim 11, further comprising:
a radiation source configured to irradiate a sample;
a radiation detector configured to detect radiation scattered from the irradiated sample; and
a generator to generate a signal corresponding to the intensity of the scattered radiation; and

15. The system of claim 11, wherein the system is capable of creating the PDF on-demand.

16. The system of claim 11, wherein the system applies the ad hoc correction functions automatically.

17. The system of claim 11, further comprising a display.

18. The system of claim 17, wherein the display is configured to display the PDF of the sample.
